(19) United States
(12) Patent Application Publication
(10) Pub. No.: US 2019/0219096 A1
(43) Pub. Date: Jul. 18, 2019

(54) BALL JOINT DEVICE

(71) Applicant: KYUNG CHANG INDUSTRIAL CO., Ltd., Daegu (KR)

(72) Inventors: Kyu-Jung Kim, Daegu (KR); Jae-Hyoung Park, Daegu (KR)

(21) Appl. No.: 16/233,482

(22) Filed: Dec. 27, 2018

(30) Foreign Application Priority Data
Jan. 15, 2018 (KR) 10-2018-0005027

(51) Int. Cl. F16C 11/10; F16C 11/06

(52) U.S. Cl. CPC F16C 11/106; F16C 2226/12; F16C 11/069; F16C 11/0623

(57) ABSTRACT

A joint ball device which is connected to a ball end of a control lever may be provided. The joint ball device includes: a ball seat which is formed to have a hollow cylindrical body and at least a pair of slots formed in a longitudinal direction of the body from an end of the body, and which includes a receiving portion defined by the body so as to receive the ball end of the control lever on the end of the body, and includes a stopper which protrudes from an outer circumferential surface of the body; and a cable end portion which is connected to a shift cable and is fastened to the ball seat. The stopper of the ball seat is fastened to the cable end portion.

### CROSS-REFERENCE TO RELATED APPLICATIONS

This application claims the benefit of Republic of Korea Patent Application No. 10-2018-0005027 filed on Jan. 15, 2018, which is incorporated by reference in its entirety.

### BACKGROUND

### Field

The present disclosure relates to a ball joint device and more particularly to a ball joint device which is connected to the ball end of the control lever of a vehicle.

### Description of the Related Art

As with a steering wheel of a direction changing device of a vehicle, the transmission of the vehicle enables a driver to manually change the shift position of the vehicle. For the purpose of the operation of the transmission, a shift lever which is exposed to the side or front of a driver's seat to allow the driver to easily operate the transmission is installed.

When a user operates the shift lever in the interior of the vehicle, transmission of power between the shift lever and the transmission is performed by a shift cable, and thus, the shift state is changed. Then, on the basis of an electrical signal corresponding to the changed shift state, parts required to drive and stop the vehicle, such as an engine, are operated.

Therefore, the shift lever is structured to be fastened to the shift cable. The shift lever may include a ball end which makes it easier to be fastened to and released from the shift cable. An end shift lever having a ball shape applied thereto transmits the gear-shifting by changing a relative phase motion which is generated at the time of performing the shifting into a phase motion having the same cable end portion. As a result, shift smoothness is increased at the beginning of the gear-shifting, and it is easier to shift the gear even by a small operation power, so that shift operation feeling can be reliably obtained.

According to such a conventional technology, the ball end is easily fastened to the ball joint device. However, the ball end is released from the ball joint device by using separate tools. Moreover, the ball end is released or stripped in a direction opposite to the release operation direction after the ball end is fastened, so that it is difficult to release the ball end.

Accordingly, there is a demand for a ball joint device capable of allowing the ball end of the control lever to be easily fastened to the ball joint device or to be easily released from the ball joint device, without using separate members.

### SUMMARY

The object of the present disclosure is to provide a ball joint device capable of allowing the ball end to be easily fastened to the ball joint device or to be easily released from the ball joint device.

One embodiment is a joint ball device which is connected to a ball end of a control lever. The joint ball device includes: a ball seat which is formed to have a hollow cylindrical body and at least a pair of slots formed in a longitudinal direction of the body from an end of the body, and which includes a receiving portion defined by the body so as to receive the ball end of the control lever on the end of the body, and includes a stopper which protrudes from an outer circumferential surface of the body; and a cable end portion which is connected to a shift cable and is fastened to the ball seat. The stopper of the ball seat is fastened to the cable end portion.

The cable end may include: a seat part on which the ball seat is seated; a first support which is formed to extend vertically from the seat part and has a first opening by which the stopper is caught; and a second support which is formed to extend vertically from the seat part and supports the ball seat.

The first support may be formed to taper from a top surface of the first support to the first opening.

The joint ball device may further include an elastic member located between the cable end portion and the outer circumferential surface of the body of the ball seat. The second support may include a catching portion which restricts the elastic member on the outer circumferential surface of the body of the ball seat when the ball seat and the cable end portion are fastened to each other.

The second support may have a second opening.

The joint ball device may further include an elastic member located between the cable end portion and the outer circumferential surface of the body of the ball seat.

The elastic member may be any one of a spring member and a rubber member.

The ball seat may further include a handle which is formed on the other end of the body and has a diameter larger than that of the body of the ball seat.

The handle may have an outer circumferential surface thereof having a screw thread formed thereon.

The receiving portion of the ball seat may have a shape corresponding to the ball end.

The body defining the receiving portion may further include a groove formed along the outer circumferential surface of the body.

The ball seat may further include a flange which is formed to extend vertically outward from the outer circumferential surface of the body.

The present disclosure can provide a ball joint device capable of allowing the ball end to be easily fastened to and released from the ball joint device.

According to the embodiment of the present disclosure, when a repetitive operation (gear shifting) is performed with the shift cable fastened to the ball end, the ball seat rotates. Therefore, unlike a fixed type ball seat, uneven wear does not occur, and thus, excellent durability is obtained.

According to the embodiment of the present disclosure, it is possible to obtain rigidity even without using separate members.

### BRIEF DESCRIPTION OF THE DRAWINGS

FIG. 1 is a perspective view of a ball joint device according to an embodiment of the present disclosure;

FIG. 2 is an exploded view of the ball joint device according to the embodiment of the present disclosure;

FIG. 3 is a perspective view of a ball seat of FIG. 2 according to the embodiment of the present disclosure;

FIG. 4 is a view of the ball seat of FIG. 3 as viewed from the bottom according to the embodiment of the present disclosure;

FIG. 5 is a perspective view of a cable end portion of FIG. 2 according to the embodiment of the present disclosure;

FIG. 6 is a cross sectional view showing that an elastic member is elastically deformed in the ball joint device according to the embodiment of the present disclosure;

FIG. 7 is a cross sectional view showing that the elastic member is elastically restored in the ball joint device of FIG. 6 according to the embodiment of the present disclosure; and

FIG. 8 is a sectional perspective view of the ball joint device of FIG. 6 according to the embodiment of the present disclosure.

### DETAILED DESCRIPTION

An embodiment of the present disclosure will be described in detail with reference to the accompanying drawings. In the components of the present invention, detailed descriptions of what can be clearly understood and easily carried into practice through prior art by those skilled in the art will be omitted to avoid making the subject matter of the present invention unclear.

### Embodiment

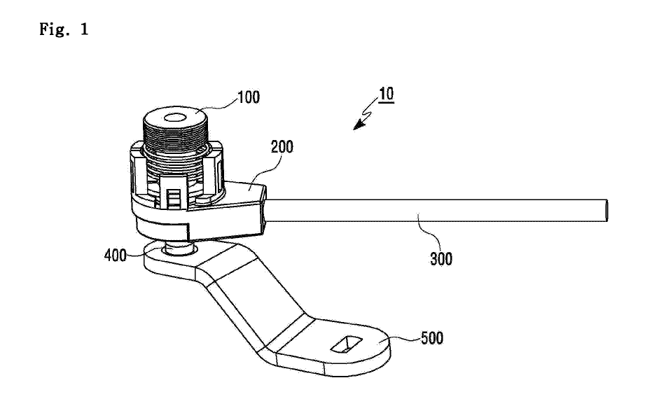

Hereinafter, a ball joint device 10 according to an embodiment of the present disclosure will be described with reference to FIGS. 1 to 8.

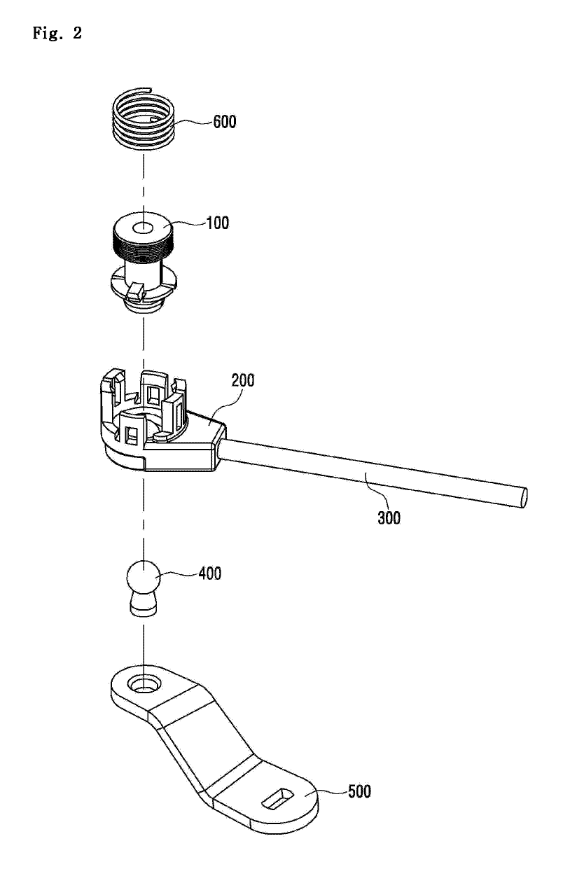

FIG. 1 is a perspective view of the ball joint device according to the embodiment of the present disclosure. FIG. 2 is an exploded view of the ball joint device according to the embodiment of the present disclosure.

Referring to FIGS. 1 and 2, the ball joint device 10 according to the embodiment of the present disclosure connects a shift lever to a shift cable 300 or a control cable. When a user operates the shift lever, the ball joint device 10 is able to transmit the power from the shift lever to the shift cable 300.

Specifically, the ball joint device 10 connects the shift cable 300 to a ball end 400 of the shift lever (not shown). The ball end 400 is connected to a TM lever 500. The TM lever 500 drives a transmission.

For this, the ball joint device 10 includes a ball seat 100 fastened to the ball end 400 of the shift lever and includes a cable end portion 200 of the shift cable 300. The ball seat 100 is fastened to the cable end portion 200.

Also, the ball joint device 10 may further include an elastic member 600 located between the ball seat 100 and the cable end portion 200. The elastic member 600 is located between the ball seat 100 and the cable end portion 200. The elastic member 600 may be a spring formed by winding in the form of a coil a string material having a circular or polygonal cross section. Here, elastic member 600 is not limited to the spring and includes all members that can be elastically deformed and restored as the ball seat 100 moves. For example, the elastic member may be a rubber member. When the elastic member 600 is a spring, the elastic member 600 is wound on the outer circumferential surface of the ball seat 100.

<Ball Seat 100>

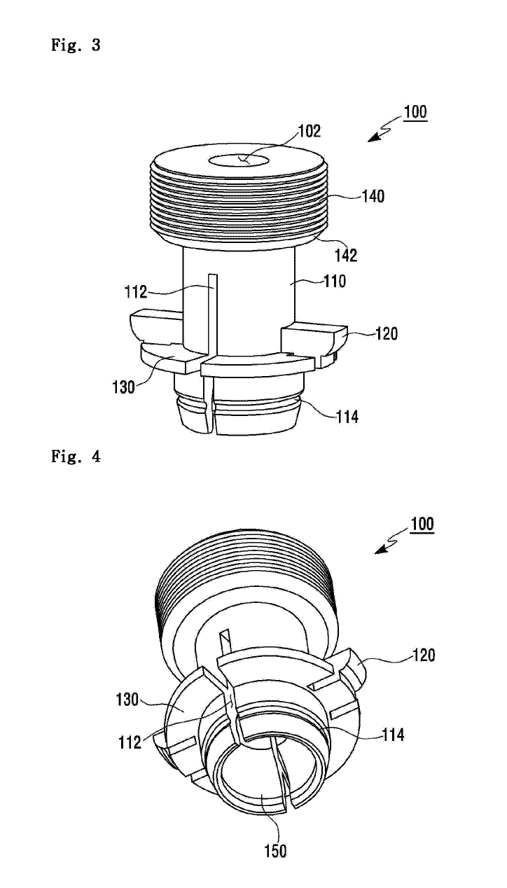

FIGS. 3 and 4 are views showing the ball seat 100 shown in FIG. 2. Specifically, FIG. 3 is a perspective view of the ball seat. FIG. 4 is a view of the ball seat as viewed from the bottom.

Referring to FIGS. 3 and 4, the ball seat 100 is formed to have a hollow cylindrical body 110. That is, the body 110 of the ball seat 100 has a cavity 102 in the central portion thereof. The body 110 has at least a pair of slots 112 formed from the end thereof in the longitudinal direction thereof. While the embodiment shows that the pair of slots 112 is formed in the body 110, a different number of slots may be formed. For example, three slots may be formed. The slots may be located at an equal interval along the outer circumferential surface of the body 110.

The body 110 includes a receiving portion 150, a pair of stopper 120, a handle 140, and a flange 130.

The receiving portion 150 is defined by the body 110 so as to receive the ball end 400 of the control lever on one end of the body 110. The ball end 400 is inserted into and received in the receiving portion 150 of the ball seat 100. The ball end 400 has a spherical shape. The receiving portion 150 has a shape corresponding to the ball end 400. The entrance of the receiving portion 150 into which the ball end 400 is inserted has a circular shape. Therefore, the entrance of the receiving portion 150 is smaller than the diameter of the ball end 400. The side surface of the receiving portion 150 has a curved shape corresponding to the spherical shape of the ball end 400. The body 100 defining the receiving portion 150 has a groove 114 formed along the outer circumferential surface thereof. When the ball end 400 is inserted into the receiving portion 150, the groove 114 makes it easier for the ball end 400 to be inserted into the receiving portion 150.

The ball end 400 is inserted into the body 110 from the end thereof in which the receiving portion 150 of the body 110 has been formed. When the ball end 400 is inserted into the body 110 of the ball end 400, the slots of the body 110 allow the body 110 to be easily deformed.

The pair of stoppers 120 protrudes from the outer circumferential surface of the body 110 in directions opposite to each other.

When the ball seat 100 and the cable end portion 200 are coupled to each other, the pair of stoppers 120 is fastened to the cable end portion 200. For example, the stopper 120 is inserted into the openings formed in the cable end portion 200, thereby preventing the ball seat 100 from being separated from the cable end portion 200.

When the ball seat 100 is seated on the cable end portion 200, the pair of stoppers 120 is inserted into the openings formed in the cable end portion 200. Therefore, the ball seat 100 slides within a predetermined stroke.

The handle 140 is formed on the other end of the body 110 and has a diameter larger than that of the body 110 of the ball seat 100. The handle 140 has a screw thread formed on the outer circumferential surface thereof. The handle 140 allows a worker to hold the ball seat 100 when separating or releasing the ball end 400 from the ball joint device 10. Since the screw thread is formed on the outer surface of the handle 140, it is possible to prevent the hand of the worker from sliding from the ball seat 100 when separating or releasing the ball end 400 from the ball joint device 10.

The handle 140 may have an inclined portion 142 which is located in the connection portion between the outer circumferential surface of the handle 140 and the outer circumferential surface of the body 110.

The flange 130 is formed to extend vertically outward from the outer circumferential surface of the body 110. When the ball seat 100 and the cable end portion 200 are coupled to each other, the flange 130 supports the elastic member 600 located between the ball seat 100 and the cable end portion 200. Therefore, the elastic member 600 located between the ball seat 100 and the cable end portion 200 can be supported on the outer circumferential surface of the ball seat 100. That is, the flange 130 supports the elastic member 600 to allow the elastic member 600 to be elastically deformed by a pressure.

For example, assuming that the elastic member 600 is a spring, when the spring 600 is pressure-deformed by a pressure, the flange 130 supports the elastic member 600 against the pressure to allow the elastic member 600 to be pressure-deformed.

<Cable End Portion 200>

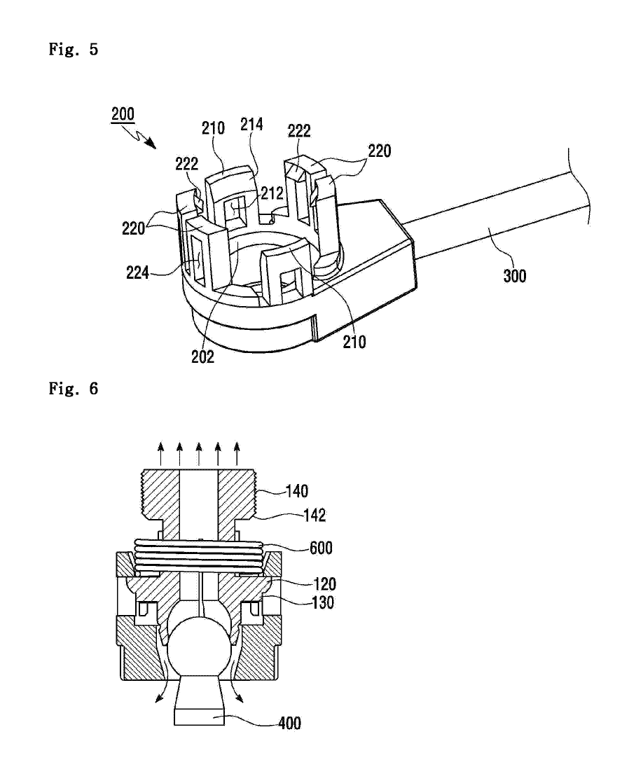

FIG. 5 is a perspective view of the cable end portion of FIG. 2. Referring to FIG. 5, the cable end portion 200 is connected to the shift cable 300 and is fastened to the above-mentioned ball seat 100.

The cable end portion 200 has a seat part 202, a first support 210, and a second support 220.

The ball seat 100 is seated on the seat part 202. Specifically, the body 110 of the ball seat 100 is placed on the seat part 202.

The first support 210 is formed to extend vertically from the seat part 202 and includes a first opening 212 by which the stopper 120 is caught. When the ball seat 100 is fastened to the cable end portion 200, the stopper 120 of the ball seat 100 is inserted into the first opening 212 of the first support 210. When the ball seat 100 is fastened to the cable end portion 200, the ball seat 100 slides within a certain stroke defined by the first opening 212 accordingly.

In this case, when the elastic member 600 is located on the outer circumferential surface of the ball seat 100, the ball seat 100 is elastically deformed by a pressure. When the pressure is removed, the elastic member 600 returns to its original state within a certain stroke defined by the first opening 212.

The first support 210 is formed to taper from the top surface of the first support 210 to the first opening 212 (see reference numeral 214). While FIG. 5 shows two first supports 210, there is no limitation to this.

The second support 220 is formed to extend vertically from the seat part 202. The second support 220 supports the ball seat 100 placed on the seat part 202. Also, the second support 220 includes a catching portion 222. The catching portion 222 restricts the elastic member 600 on the outer circumferential surface of the body 110 of the ball seat 100 when the ball seat 100 and the cable end portion 200 are fastened to each other.

Specifically, when the ball seat 100 is fastened to the cable end portion 200, the elastic member 600 is restricted on the outer circumferential surface of the body 110 of the ball seat 100 by the catching portion 222, and thus is not separated from the ball seat 100.

The second support 220 may have a second opening 224. While the second support 220 has the second opening 224 in the embodiment, the second support 220 may not have the second opening 224.

Further, while FIG. 5 shows four second supports 220, there is no limitation to this. For example, two second supports 220 may be provided. In this case, the two second supports 220 are disposed in positions facing each other.

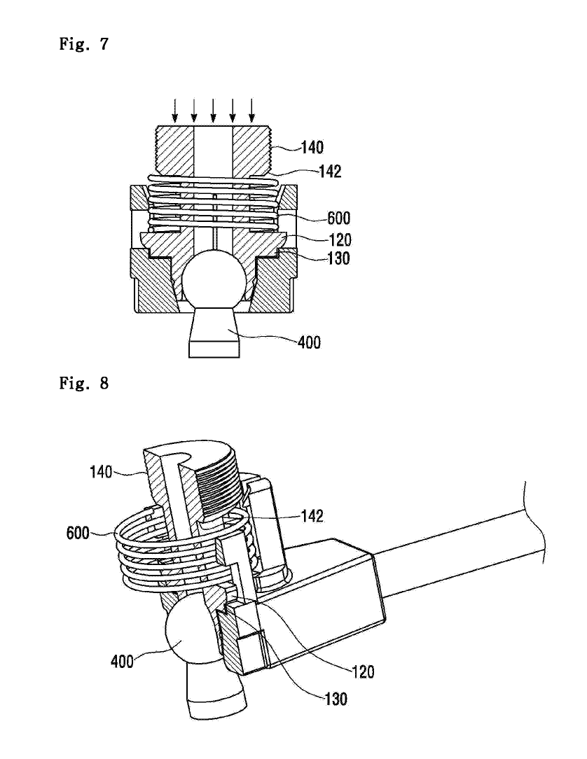

FIGS. 6 to 8 are views for describing the fastening and fastening operation of the ball seat and the cable end portion of the ball joint device according to the embodiment of the present disclosure. FIG. 6 is a cross sectional view showing that the elastic member is elastically deformed in the ball joint device according to the embodiment of the present invention. FIG. 7 is a cross sectional view showing that the elastic member is elastically restored in the ball joint device of FIG. 6. FIG. 8 is a sectional perspective view of the ball joint device of FIG. 6.

Referring to FIG. 3, FIG. 4, FIG. 5 and FIG. 7, when the ball end 400 is inserted into the receiving portion 150, the ball end 400 is pressed by the entrance of the receiving portion 150. In this case, the ball end 400 is fitted at the entrance of the receiving portion 150 before the ball end 400 is completely received in the receiving portion 150. In this state, if the ball end 400 is continuously pushed toward the receiving portion 150, the body 110 of the ball seat 10 is pushed in the insertion direction of the ball end 400, and is caught in the first opening 210 by the stopper 120 and is not pushed any more.

The elastic member 600 disposed on the outer circumferential surface of the body 110 is pressure-deformed by the body 110 of the ball seat 100, which is pushed upward by the pressure applied in the insertion direction of the ball end 400. As described above, the elastic member 600 is fixed without being separated from the ball seat 100 by the catching portion 222 formed on the second support 220.

Here, when the body 110 of the ball seat 100 is not pushed any more by the stopper 120, the pressure applied to the ball end 400 reacts against the ball seat 100, so that the ball end 400 is inserted into the receiving portion 150 of the body 110 of the ball seat 100.

Subsequently, referring to FIG. 8, when the pressure applied to the ball end 400 is removed, the elastic member 600 is elastically restored. Accordingly, one side of the elastic member 600 is supported by the catching portion 222 of the second support 220 of the body 110 and the other side is supported by the flange 130 of the body 110 of the ball seat 100.

In this case, since the elastic member 600 is elastically restored in a direction opposite to the insertion direction of the ball end 400, the body 110 of the ball seat 100 is pushed in the direction opposite to the insertion direction of the ball end 400. The lower portion of the stopper 120 slides downward within the first opening 121 of the first support 220 of the body 110.

As such, according to the embodiment of the present disclosure, when a repetitive operation (gear shifting) is performed with the shift cable fastened to the ball end, the ball seat rotates. Therefore, unlike a fixed type ball seat, uneven wear does not occur, and thus, excellent durability is obtained.

The features, structures and effects and the like described in the embodiments are included in at least one embodiment of the present disclosure and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present disclosure were described above, these are just examples and do not limit the present disclosure. Further, the present invention may be changed and modified in various ways, without departing from the essential features of the present invention, by those skilled in the art. That is, the components described in detail in the embodiments of the present disclosure may be modified. Further, differences due to the modification and application should be construed as being included in the scope and spirit of the present invention, which is described in the accompanying claims.

What is claimed is:

1. A joint ball device which is connected to a ball end of a control lever, the joint ball device comprising:
a ball seat which is formed to have a hollow cylindrical body and at least a pair of slots formed in a longitudinal direction of the body from an end of the body, and which comprises a receiving portion defined by the body so as to receive the ball end of the control lever on the end of the body, and comprises a stopper which protrudes from an outer circumferential surface of the body; and
a cable end portion which is connected to a shift cable and is fastened to the ball seat, wherein the stopper of the ball seat is fastened to the cable end portion.

2. The joint ball device of claim 1, wherein the cable end comprises:
a seat part on which the ball seat is seated;
a first support which is formed to extend vertically from the seat part and has a first opening by which the stopper is caught; and
a second support which is formed to extend vertically from the seat part and supports the ball seat.

3. The joint ball device of claim 2, wherein the first support is formed to taper from a top surface of the first support to the first opening.

4. The joint ball device of claim 2, further comprising an elastic member located between the cable end portion and the outer circumferential surface of the body of the ball seat, wherein the second support comprises a catching portion which restricts the elastic member on the outer circumferential surface of the body of the ball seat when the ball seat and the cable end portion are fastened to each other.

5. The joint ball device of claim 2, wherein the second support has a second opening.

6. The joint ball device of claim 1, further comprising an elastic member located between the cable end portion and the outer circumferential surface of the body of the ball seat.

7. The joint ball device of claim 6, wherein the elastic member is any one of a spring member and a rubber member.

8. The joint ball device of claim 7, wherein the ball seat further comprises a handle which is formed on another end of the body and has a diameter larger than that of the body of the ball seat.

9. The joint ball device of claim 8, wherein the handle has an outer circumferential surface thereof having a screw thread formed thereon.

10. The joint ball device of claim 1, wherein the receiving portion of the ball seat has a shape corresponding to the ball end.

11. The joint ball device of claim 1, wherein the body defining the receiving portion further comprises a groove formed along the outer circumferential surface of the body.

12. The joint ball device of claim 1, wherein the ball seat further comprises a flange which is formed to extend vertically outward from the outer circumferential surface of the body.
